(19) United States
(12) Patent Application Publication
(10) Pub. No.: US 2021/0033239 A1
(43) Pub. Date: Feb. 4, 2021

(54) Protective Sleeve for Hydrovac Excavation Equipment

(71) Applicant: William Auclair, Hinton (CA)

(72) Inventor: William Auclair, Hinton (CA)

(21) Appl. No.: 16/528,408

(22) Filed: Jul. 31, 2019

(51) Int. Cl. F16L 57/06; E02F 3/92

(52) U.S. Cl. CPC F16L 57/06; E21B 7/18; E02D 2600/20; E02F 3/9206

(57) ABSTRACT

A protective sleeve configured to be circumferentially disposed around a portion of a dig wand on a hydrovac excavation system. The protective sleeve includes a body that is planar in manner and flexible. In a preferred embodiment of the present invention the body includes a first layer, a second layer and a third layer. The first layer and third layer are manufactured from a synthetic rubber or polymer plastic. The second layer is intermediate the first layer and third layer and is manufactured from an impact absorbing material such as but not limited to silicone gel. A plurality of fasteners are integrally secured on the body and are arranged in a first set and a second set. The plurality of fasteners are mateable and are configured to surroundably secure the protective sleeve around a portion of a dig wand.

### FIELD OF THE INVENTION

The present invention relates generally to excavation systems, more specifically but not by way of limitation, a protective sleeve configured to be surroundably mounted a portion of a dig tube of a hydrovac excavation system wherein the present invention provides impact and abrasion protection for piping adjacent thereto.

### BACKGROUND

During pipeline repair or replacement there are various techniques for excavating the areas around the pipeline so as to create the necessary space for the intended task of repairing or replacing a section of a pipe that is buried underground. For these applications it is common to use equipment such as hydrovac excavation systems. Hydrovac excavation system are comprised of a vacuum system and a high pressure water system wherein the combination of the two are utilized to dislodge and remove dirt from a targeted area. The systems include a water source operably coupled to a digging wand wherein the digging wand is used to direct a stream of high pressure water to dislodge dirt proximate the discharge end of the digging wand from which water is regressing therefrom. The digging wand is typically a metal tube that can vary in diameter and is configured so as to be extendible utilizing mateable connections and clamps.

While the aforementioned is effective at removal of dirt around pipelines there are risks when utilizing hydrovac equipment proximate pipelines. As it is often necessary to clear the area underneath the pipe as as well as the sides, the dig wand will often contact the pipe for which the area is being cleared around for repair, replacement or inspection. During the process of clearing the area completely around and underneath the pipe, the dig wand will often continuously contact the pipe adjacent thereto. The aforementioned presents an inherent risk as often the pipes have a fluid or gas therein that is at a high pressure. Contact from the metal dig wand can sometimes damage the pipe wherein a rupture or leak may began to occur which is a significant safety risk. The dig wand must be placed proximate the pipe in order to remove the dirt but this placement can result in unwanted damage to the pipe.

Accordingly, there is a need for a protective sleeve configured to be circumferentially mounted to a portion of a dig wand of a hydrovac excavation system wherein the protective sleeve inhibits damage to the pipe while the area proximate thereto is being excavated.

### SUMMARY OF THE INVENTION

It is the object of the present invention to provide a protective sleeve for a dig wand of a hydrovac excavation system so as to inhibit damage to pipes adjacent thereto during the excavation process wherein the present invention includes a body that is planar in manner.

Another object of the present invention is to provide a dig wand protective sleeve configured to be surroundably mounted a portion of a dig wand of a hydrovac excavation system wherein the body is flexible and is formed from three layers.

A further object of the present invention is to provide a protective sleeve for a dig wand of a hydrovac excavation system so as to inhibit damage to pipes adjacent thereto during the excavation process wherein the body includes fasteners mounted to the surfaces thereof that are mateably coupled so as to facilitate the surroundable mounting of the body to a portion of a dig wand.

Still another object of the present invention is to provide a dig wand protective sleeve configured to be surroundably mounted a portion of a dig wand of a hydrovac excavation system wherein the first and third layer of the body are the outer layers and are manufactured from a synthetic rubber or plastic polymer type material.

An additional object of the present invention is to provide a protective sleeve for a dig wand of a hydrovac excavation system so as to inhibit damage to pipes adjacent thereto during the excavation process wherein the second layer of the body is intermediate the third layer and is manufactured from an impact absorbing material such as but not limited to silicon gel.

Yet a further object of the present invention is to provide a dig wand protective sleeve configured to be surroundably mounted a portion of a dig wand of a hydrovac excavation system wherein the fasteners secured to the body facilitate the ability to circumferentially mount a portion of a dig wand connection wherein the connection consists of two different diameters.

Another object of the present invention is to a provide a protective sleeve for a dig wand of a hydrovac excavation system so as to inhibit damage to pipes adjacent thereto during the excavation process wherein the body of the present invention is manufactured utilizing a high visibility color such as but not limited to yellow or orange.

An alternate object of the present invention is to provide a dig wand protective sleeve configured to be surroundably mounted a portion of a dig wand of a hydrovac excavation system wherein the body is provided in alternate lengths.

Still a further object of the present invention is to provide a protective sleeve for a dig wand of a hydrovac excavation system so as to inhibit damage to pipes adjacent thereto during the excavation process wherein the fastener arrangement facilitates adjustable sizing so as to surroundably mount dig wand portions of several diameters.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is perspective view of a dig wand having the present invention surroundably mounted to a portion thereof; and

FIG. 2 is a cross-sectional view of the body of the present invention; and

FIG. 3 is a top view of the upper surface of the body of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a protective sleeve 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the protective sleeve 100 includes a body 10. The body 10 is planar in its first position and is manufactured from materials that promote the ability for the body 10 to be circumferentially mounted to a portion of an exemplary dig wand 99 as further discussed herein. The body 10 includes an upper surface 11 and lower surface 12. The body 10 includes a first layer 15, a second layer 16 and a third layer 17. The first layer 15 and third layer 16 are manufactured from a material such as but not limited to a synthetic rubber or plastic polymer sheet material. By way of example but not limitation, in a preferred embodiment of the present invention the first layer 15 and third layer 17 are manufactured from Hypalon. The first layer 15 and third layer 17 are manufactured to endure abrasive movements against materials such as but not limited to rocks and metal pipe. The third layer 17 is desirable in a preferred embodiment as the material thereof will inhibit damage to the body 10 that can be caused by clamps and other features of the dig wand 99 to which the third layer 17 will be adjacent thereto ensuing mounting of the protective sleeve 100 to a dig wand 99.

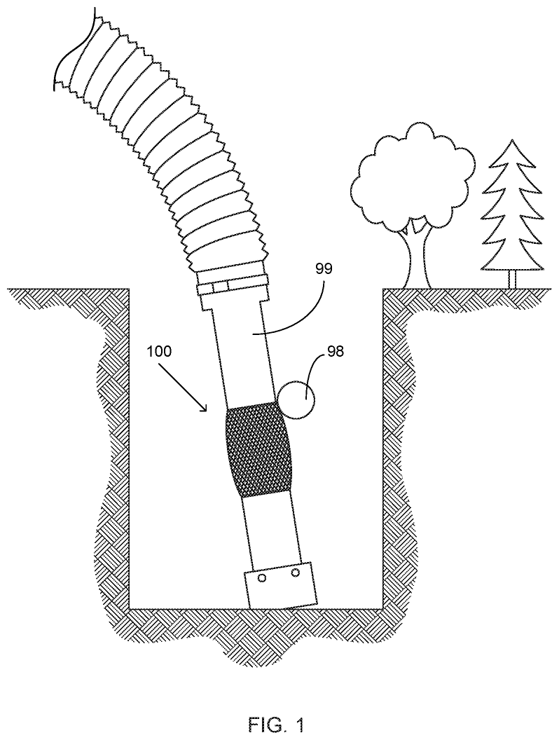

While a first layer 15 and third layer 17 are discussed herein for a preferred embodiment of the present invention the protective sleeve 100, it is contemplated within the scope of the present invention that the protective sleeve 100 could have as few as two layers wherein one layer is designed for impact absorption and an outer layer configured as discussed herein for the first layer 15 and third layer 17. Still referring to FIG. 2 herein, the body 10 includes a second layer 16. The second layer 16 is intermediate the first layer 15 and second layer 17. The second layer 16 is designed to absorb impact forces so as to reduce damage to both the dig wand 99 and an exemplary pipe 98 adjacent thereto. As illustrated herein in FIG. 1, the dig wand 99 is often adjacent to a pipe 98 during the excavation process. The protective sleeve 100 functions to inhibit damage to the pipe 98 during the excavation process as illustrated. The second layer 16 provides a reduction in impact forces and in a preferred embodiment is manufactured from a material such as but not limited to silicon gel. It is contemplated within the scope of the present invention that second layer 16 could be manufactured in various thickness. It is further contemplated within the scope of the present invention that the body 10 could be manufactured in alternate sizes having alternate lengths and widths so as to be able to be circumferentially mounted to a dig wand 99.

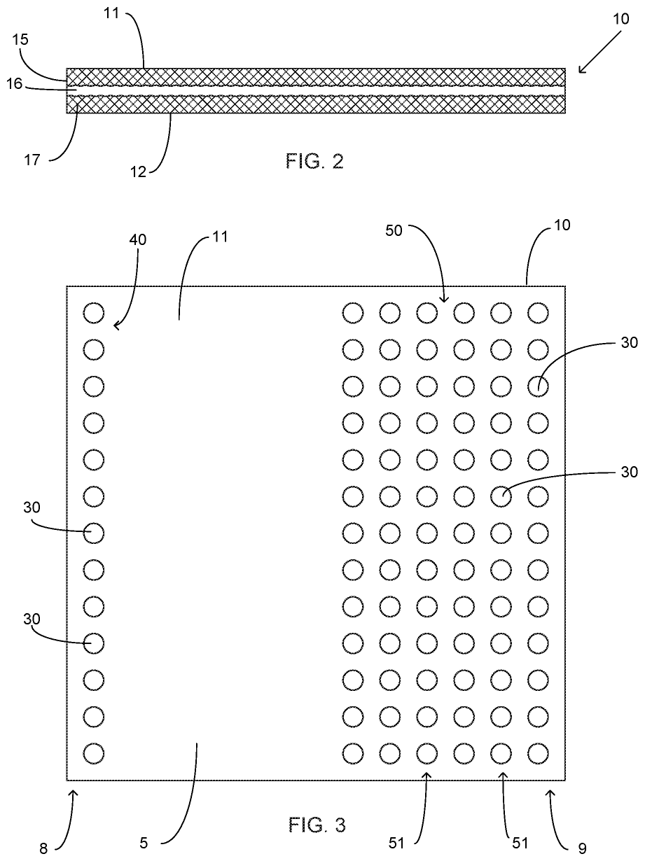

Referring now to FIG. 3, the upper surface 11 of the body 10 is illustrated therein with fasteners 30. It should be understood within the scope of the present invention that the annular shapes representing the fasteners 30 are for illustrative purposes only. It is contemplated within the scope of the present invention that the fasteners 30 could be manufactured from various mateable mechanical fasteners that are operable to secure to each other subsequent the body 10 being circumferentially mounted to a dig wand 99. The fasteners 30 are organized into a first set 40 and a second set 50. The first set of fasteners 40 are configured to penetrate through the body 10 in order to mateably couple with a portion of the second set of fasteners 50 subsequent the body 10 being circumferentially disposed a dig wand 99. As previously discussed herein, it is contemplated within the scope of the present invention that the fasteners 30 could be numerous alternate types of mateable mechanical fasteners. The first set of fasteners 40 are disposed on the first end 8 of the body 10 and the second set of fasteners 50 are proximate the second end 9 of the body 10. A void 5 is present intermediate the first set of fasteners 40 and the second set of fasteners 50. This configuration is provided as the fasteners 30 need not be present on the entire body 10 for the desired application of the present invention.

Upon the body 10 being surroundably mounted to a portion of a dig wand, fasteners 30 from the second set of fasteners 50 are operably coupled to the fasteners 30 of the first set of fasteners 40. As mentioned herein, the fasteners 30 of the first set of fasteners 40 have a portion thereof extending through the body 10 (not particularly illustrated herein) that are operable to couple with the proximate fasteners 30 of the second set of fasteners 50. The second set of fasteners 30 is configured as illustrated herein so as to provide the ability to accommodate dig wands 99 of alternate diameters. Depending on the diameter of the dig wand 99, a user will utilize alternate columns 51 of the second set of fasteners 50. Furthermore, the configuration of the first set of fasteners 40 and second set of fasteners 50 provide the ability for the protective sleeve 100 to be securely mounted to a portion of a dig wand 99 wherein there is a coupling of two portions that have an alternate diameter. By way of example but not limitation, a dig wand 99 extension can often include a reducing union wherein an eight inch diameter pipe is joined to a six inch diameter pipe. Positioning the fasteners 30 into the first set of fasteners 40 and second set of fasteners 50 allow a user to couple the required fasteners 30 in order to tightly secure the protective sleeve 98.

While a desired fastener 30 configuration is illustrated and discussed herein, it is contemplated within the scope of the present invention that the body 10 could be provided with alternate fastener 30 configurations in order to achieve the desired objective discussed herein. Furthermore, while the protective sleeve 100 has been discussed herein for a specific application, it should be understood within the scope of the present invention that the protective sleeve 100 could be surroundably secured to alternate objects so as to provide protection thereof.

It should be understood within the scope of the present invention that the term herein, dig wand, is to be understood to apply to both commonly utilized terms in the field of invention of dig wand and dig tube. As is known in the art dig wands and dig tubes are both utilized in hydro-excavation and it is the function of the present invention to circumferentially surround either so as to provide protection to an adjacent object such as but not limited to a utility line.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A protective sleeve configured to be circumferentially disposed around an object so as to provide protection thereof comprising:
a body, said body having at least two layers, said body being planar in manner and flexible, said body having an upper surface and a lower surface, said body being movable to a second position wherein in said second position said body is circumferentially disposed around an object; and
a plurality of fasteners, said plurality of fasteners being disposed on said body proximate opposite ends thereof, said plurality of fasteners operable to secure said body in the second position ensuing being surroundably secured an object.

2. The protective sleeve as recited in claim 1, wherein said second layer is manufactured from an impact absorbing material and is adjacent an object to which the protective sleeve is surroundably secured when said body is in the second position.

3. The protective sleeve as recited in claim 2, wherein said first layer is manufactured from a material selected from one of the following: synthetic rubber or plastic polymer.

4. The protective sleeve as recited in claim 3, wherein said plurality of fasteners are arranged on said body in a first set and a second set.

5. The protective sleeve as recited in claim 4, wherein said first set of fasteners are proximate a first end of said body.

6. The protective sleeve as recited in claim 5, wherein said second set of fasteners are proximate a second end of said body.

7. A protective sleeve configured to be surroundably mounted a portion of a dig wand of a hydrovac excavation system wherein the protective sleeve comprises:
a body, said body having a first layer, a second layer and a third layer, said body having an upper surface and a lower surface, said body having a first end and a second end, said body being flexible, said body having a first position and a second position, said body being planar in manner in said first position, said body being circumferentially disposed the portion of the dig wand in said second position;
a plurality of fasteners, said plurality of fasteners being secured to said body, said plurality of fasteners being organized in a first set and a second set, said second set and said first set of the plurality of fasteners being mateable, said plurality of fasteners configured to secure said body in said second position; and
wherein said first set and second set of fasteners are arranged in columns intermediate an upper edge and a lower edge of said body.

8. The protective sleeve configured to be surroundably mounted a portion of a dig wand as recited in claim 7, wherein said first layer and said third layer are manufactured from a material selected from one of the following: synthetic rubber or plastic polymer.

9. The protective sleeve configured to be surroundably mounted a portion of a dig wand as recited in claim 8, wherein said second layer is intermediate said first layer and said third layer and is manufactured from a silicone gel.

10. The protective sleeve configured to be surroundably mounted a portion of a dig wand as recited in claim 9, wherein said first set of fasteners and said second set of fasteners have a void therebetween.

11. The protective sleeve configured to be surroundably mounted a portion of a dig wand as recited in claim 10, wherein said body is manufactured from a high visibility color.

12. The protective sleeve configured to be surroundably mounted a portion of a dig wand as recited in claim 11, wherein a portion of the first set of fasteners extends outward from said lower surface of said body.

13. A protective sleeve configured to be surroundably mounted a portion of a dig wand of a hydrovac excavation system wherein the protective sleeve comprises:
a body, said body having a first layer, a second layer and a third layer, said second layer being intermediate said first layer and said third layer, said body having an upper edge and a lower edge, said body having an upper surface and a lower surface, said body having a first end and a second end, said body being flexible, said body having a first position and a second position, said body being planar in manner in said first position, said body being circumferentially disposed the portion of the dig wand in said second position;
a plurality of fasteners, said plurality of fasteners being secured to said body, said plurality of fasteners being mateable, said plurality of fasteners being organized in a first set and a second set, said plurality of fasteners configured to secure said body in said second position, said first set and second set of fasteners are arranged in columns wherein said first set of said fasteners are proximate said first end of said body and said second set of fasteners are proximate said second end of said body.

14. The protective sleeve configured to be surroundably mounted a portion of a dig wand as recited in claim 13, wherein said second set of said fasteners includes a plurality of columns of fasteners.

15. The protective sleeve configured to be surroundably mounted a portion of a dig wand as recited in claim 14, wherein said first set of fasteners includes a single column of fasteners intermediate said upper edge and lower edge of said body.

16. The protective sleeve configured to be surroundably mounted a portion of a dig wand as recited in claim 15, wherein said second layer is manufactured from a silicon gel.

17. The protective sleeve configured to be surroundably mounted a portion of a dig wand as recited in claim 16, wherein said first layer and said third layer are manufactured from a material selected from one of the following: synthetic rubber or plastic polymer.

18. The protective sleeve configured to be surroundably mounted a portion of a dig wand as recited in claim 17, wherein the protective sleeve is manufactured in a high visibility color.

19. The protective sleeve configured to be surroundably mounted a portion of a dig wand as recited in claim 18, wherein a void is present intermediate said first set of fasteners and said second set of fasteners.
